(19) United States
(12) Patent Application Publication
(10) Pub. No.: US 2025/0098640 A1
(43) Pub. Date: Mar. 27, 2025

(54) Pet Collar Device

(71) Applicant: Melissa Wylie, Staten Island, NY (US)

(72) Inventor: Melissa Wylie, Staten Island, NY (US)

(21) Appl. No.: 18/885,808

(22) Filed: Sep. 16, 2024

Related U.S. Application Data
(60) Provisional application No. 63/584,955, filed on Sep. 25, 2023.

(51) Int. Cl. A01K 27/00

(52) U.S. Cl. CPC A01K 27/009; A01K 27/001; A01K 27/006

(57) ABSTRACT

A pet collar device is disclosed. More specifically, the device is an improved E collar for pets that drowns out overstimulating noises. The calming cone device comprises a body component that is configured in a cone shape that is fastened around a pet's head. The body component features a Bluetooth speaker mechanism that allows a pet owner to play calming sounds or white noise through the cone. Thus, once the device is attached to a pet, soothing sounds can be used to drown out harsh background noises that may scare pets. Accordingly, the device helps pets and their owners deal with pet anxiety surrounding fireworks, thunderstorms, or other loud environments.

### CROSS-REFERENCE TO RELATED APPLICATION

The present application claims priority to, and the benefit of, U.S. Provisional Application No. 63/584,955, which was filed on Sep. 25, 2023, and is incorporated herein by reference in its entirety.

### FIELD OF THE INVENTION

The present invention relates generally to the field of Elizabethan collars or E-collar devices for pets. More specifically, the present invention relates to a Bluetooth-equipped E collar that can be used to comfort pets during overstimulating events. Accordingly, this disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in pet soothing devices designed to alleviate anxiety and stress in pets. Anxiety in dogs and other pets can be triggered by a variety of loud and frightening noises, such as thunderstorms, fireworks, construction work, loud vehicles, and other unexpected auditory stressors. Additionally, certain visual stimuli, unfamiliar environments, or the absence of a pet owner can also contribute to a pet's heightened state of anxiety. This anxiety can manifest in several ways, leading to undesirable and potentially dangerous behaviors.

Common manifestations of anxiety in pets include howling, barking, excessive vocalization, destruction of household items such as furniture and shoes, stress chewing, and repetitive behaviors like pacing or circling. Physiological responses may also be present, including shaking, trembling, panting, drooling, and whining. In more severe cases, anxiety can cause pets to lose control over their bodily functions, resulting in incontinence. These behaviors are not only distressing for the pets but can also create stressful situations for pet owners, disrupt the household environment, and potentially lead to strained relationships with neighbors due to noise complaints or property damage.

Moreover, in situations where pets feel particularly threatened or unsafe, there is an increased risk of them attempting to escape their environment, potentially running away in a panic. Such scenarios pose significant risks as pets that flee may face dangers such as traffic accidents, encounters with other animals, or becoming lost and unable to find their way home. In extreme cases, runaway pets may suffer serious injuries or even be killed. This highlights the importance of developing effective soothing devices that can help manage pet anxiety and promote a sense of safety and security for pets, ultimately reducing the risk of dangerous behaviors and ensuring the well-being of both the pets and their owners.

Accordingly, there is a demand for an improved calming cone device that can soothe the stress and anxiety of pets in loud environments. More specifically, there is a demand for an improved calming cone device that drowns out loud noises.

Therefore, there exists a long-felt need in the art for a calming cone device that provides users with an improved E-collar for pet owners to soothe the stress and anxiety that dogs experience during intense thunderstorms, fireworks, and other overstimulating events. There is also a long-felt need in the art for a calming cone device that tunes out harsh background noises while creating peaceful and tranquil experiences for a pet to enjoy if they are stressed. Further, there is a long-felt need in the art for a calming cone device that features a Bluetooth mechanism that can drown out frightening sounds to keep a pet calm. Finally, there is a long-felt need in the art for a calming cone device that manages the pet's fear of loud noises in and out of the home, preventing them from running away out of fear.

The subject matter disclosed and claimed herein, in one embodiment thereof, comprises a calming cone device. The device is an improved E collar for pets that drowns out overstimulating noises. The calming cone device comprises a body component that is configured in a cone shape that is fastened around a pet's head. The body component features a Bluetooth speaker mechanism that allows a pet owner to play calming sounds or white noise through the cone. Thus, once the device is attached to a pet, soothing sounds can be used to drown out harsh background noises that may scare pets. Accordingly, the device helps pets and their owners deal with pet anxiety surrounding fireworks, thunderstorms, or other loud environments.

In this manner, the calming cone device of the present invention accomplishes all of the forgoing objectives and provides users with an improved collar. More specifically, the device provides a collar that soothes pets in stressful environments.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a calming cone device. The device is an E collar for pets that drowns out harsh noises. The calming cone device comprises a body component and a Bluetooth component with a speaker. Thus, once the device is attached to a pet, soothing sounds can be used to drown out harsh background noises that may scare pets.

In one embodiment, the calming cone device comprises a body component. The body component is typically configured in a conical shape but can be configured in any suitable shape as is known in the art. Typically, the body component comprises fasteners for attachment around a pet's head, and a Bluetooth component.

In one embodiment, if the body component is manufactured from a textile material, the fastener can be a zippered closure. Other types of fasteners, such as snaps, buttons, etc., can be used.

In one embodiment, the body component is sized and shaped to accommodate a variety of pet sizes. The fasteners of the body component may be adjustable in nature to ensure a secure fit.

In one embodiment, the Bluetooth component of the calming cone device is located on the interior surface of the body component, near the pet's ear. The Bluetooth component generally comprises a speaker, a power button, and a pairing button. The pairing button is used to pair the Bluetooth component with another Bluetooth-enabled device which then transmits calming sounds or music through the speaker.

In one embodiment, the calming cone device in accordance with the present invention can be produced in various colors, designs, patterns, etc., and feature logos, emblems, and or designs, such as a distributor requests and/or a user desires.

In one embodiment, the calming cone device is manufactured of a high-density polyethylene (HDPE), or any other suitable materials as is known in the art. Any number of different types of materials can be used to make the calming cone device including but not limited to plastics, nylon, textile materials, etc.

In use, the user fastens the device around the head of a pet via the fasteners located on the body component. Next, the user turns on the Bluetooth component located on the interior of the body component via a power button. Further, the user pairs the Bluetooth component with another Bluetooth-enabled device such as a smartphone via the pairing button. Finally, the user can utilize the device to play calming sounds or music for their pet to drown out harsh noises. Thus, the calming cone device provides users with an E collar that soothes the stress and anxiety that pets experience during intense thunderstorms, fireworks, or other loud events.

It will also be appreciated that there are a number of additional add-on features that can be incorporated into the device and moreover, the calming cone device can take many different forms as is known in the art.

In yet another embodiment, the calming cone device comprises a plurality of indicia.

In yet another embodiment, a method of conveniently keeping a pet calm in an overstimulating environment is disclosed. The method includes the steps of providing a calming cone device comprising a body component and Bluetooth component with a speaker. The method also comprises fastening the body component around the head of a pet. Further, the method comprises turning on the Bluetooth component via the power button. Next, the method comprises pairing the Bluetooth component with another Bluetooth-enabled device. Finally, the method comprises utilizing the device to play soothing music or sounds to drown out harsh noises and calm the pet.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the calming cone device of the present invention showing the device attached to a dog in accordance with the disclosed architecture;

FIG. 2 illustrates a side perspective view of one embodiment of the calming cone device of the present invention showing the device attached to a dog in accordance with the disclosed architecture; and

FIG. 3 illustrates a flowchart showing the method of conveniently keeping a pet calm in an overstimulating environment in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a calming cone device that provides users with an improved E collar for pet owners to soothe the stress and anxiety that dogs experience during intense thunderstorms, fireworks, and other overstimulating events. There is also a long-felt need in the art for a calming cone device that tunes out harsh background noises while creating peaceful and tranquil experiences for a pet to enjoy if they are stressed. Further, there is a long-felt need in the art for a calming cone device that features a Bluetooth mechanism that can drown out frightening sounds to keep a pet calm. Finally, there is a long-felt need in the art for a calming cone device that manages the pet's fear of loud noises in and out of the home, preventing them from running away out of fear.

The present invention, in one exemplary embodiment, is a calming cone device. The device is an improved E collar for pets that drowns out overstimulating noises. The calming cone device comprises a body component that is configured in a cone shape that is fastened around a pet's head. The body component features a Bluetooth speaker mechanism that allows a pet owner to play calming sounds or white noise through the cone. Thus, once the device is attached to a pet, soothing sounds can be used to drown out harsh background noises that may scare pets. The present invention also includes a novel method of conveniently keeping a pet calm in an overstimulating environment. The method includes the steps of providing a calming cone device comprising a body component and Bluetooth component with a speaker. The method also comprises fastening the body component around the head of a pet. Further, the method comprises turning on the Bluetooth component via the power button. Next, the method comprises pairing the Bluetooth component with another Bluetooth-enabled device. Finally, the method comprises utilizing the device to play soothing music or sounds to drown out harsh noises and calm the pet.

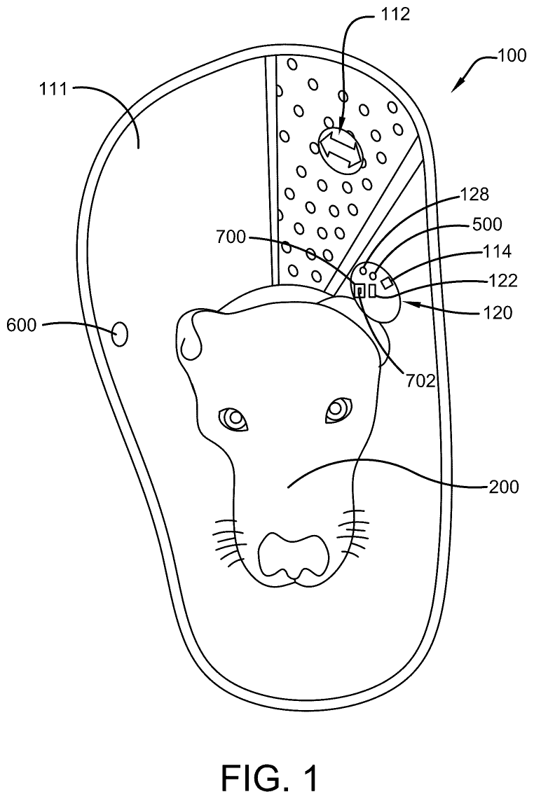

Referring initially to the drawings, FIG. 1 illustrates a perspective view of one embodiment of the calming cone device 100 of the present invention. In the present embodiment, the calming cone device 100 is an improved E collar 100 for pets that drown out overstimulating noises. The calming cone device 100 comprises a body component 110 that is configured in a cone shape. In one embodiment, the body 110 is manufactured of a high-density polyethylene (HDPE), or any other suitable materials as is known in the art. Any number of different types of materials can be used to make the calming cone device 100 including but not limited to nylon, textile materials, heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc.

The body 110 is fastened around a pet's 200 head via at least one fastener 112. The fastener 112 may be any fastener type such as but not limited to a hook and loop fastener, a snap button fastener, a buckle fastener, a strap and buckle fastener, a magnet fastener, a zipper fastener or any other adjustable fastener known in the art that allows the body 110 to be tightened and loosened around the head 200 of a pet.

It is to be appreciated that the calming cone device 100 in accordance with the present invention can be produced in various colors, designs, patterns, etc., and feature logos, emblems and or designs, such as a distributor requests and/or a user desires. In yet another embodiment, the calming cone device 100 comprises a plurality of indicia 400. The body component 110 of the device 100 may include advertising, a trademark, or other letters, designs, or characters, printed, painted, stamped, or integrated into the body component 110, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be dog, pet, or brand related.

The body component 110 features at least one Bluetooth speaker component 120. The component 110 may be positioned anywhere on an interior 111 or exterior surface 113 of the body 110. The preferred embodiment of the device 100 has a plurality of speakers 120 to create a surround-sound like experience. The component 120 may be fixedly or removably attached to the body 110 via at least one fastener 114 such as but not limited to a hook and loop fastener, an adhesive fastener, an opening, a magnet fastener, etc. In one embodiment, the speaker 120 is not attached to the component 110 and is instead a stand-alone, U-shaped flexible speaker that can be placed around the neck of the pet.

The speaker component 120 that allows a pet owner to play calming sounds or white noise within the body component 110. More specifically, the speaker component 120 is comprised of at least one wireless transmitter 500 that allows the speaker 120 to be placed in wireless electrical communication with a smart device such as but not limited to a smartphone. The smart device can be used to control a volume of a speaker 122 of the component 120 and what sounds play from the speaker 122. The component 120 is also comprised of at least one on/off button 124 and at least one pairing button 126 that allows the transmitter 500 to be paired with a smart device. In another embodiment, the component 120 may be comprised of a physical volume button 128 that allows a user to control the volume of the speaker 122. Thus, once the device 100 is attached to a pet 200, soothing sounds (such as but not limited to music, sounds, white noise, etc.) can be used to drown out harsh background noises that may scare pets.

The speaker component 120 may be powered by at least one battery 700. The battery 700 may be removable or non-removable in different embodiments. In one embodiment, the battery 700 may be rechargeable or non-rechargeable. The battery 700 may also be comprised of at least one charging port 702, such as but not limited to a USB port.

It will also be appreciated that there are a number of additional add-on components 600 that can be incorporated into the device 100 for a calming effect, such as but not limited to an essential oil dispenser 600.

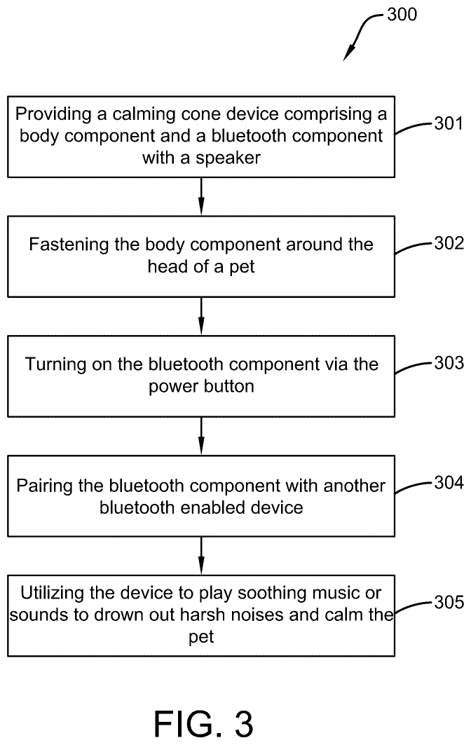

FIG. 3 illustrates a flowchart of the method 300 of conveniently keeping a pet calm in an overstimulating environment. The method includes the steps of at 301, providing a calming cone device 100 comprising a body component 110 comprised of a fastener 112 and a Bluetooth component 120 with a speaker 122. The method also comprises at 302, fastening the body component 110 around the head 200 of a pet via a fastener 112. Further, the method comprises at 303, turning on the Bluetooth component 120 via the power button 124. Next, the method comprises at 304, pairing the Bluetooth component 120 with another Bluetooth-enabled device smart device. Finally, the method comprises at 305, utilizing the device 100 to play a soothing sound within the body 110 via the speaker 122 (selected and controlled via the smart device) to drown out harsh noises and calm the pet wearing the device 100.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “calming conc device”, “E collar device”, “collar device”, and “device” are interchangeable and refer to the calming cone device 100 of the present invention.

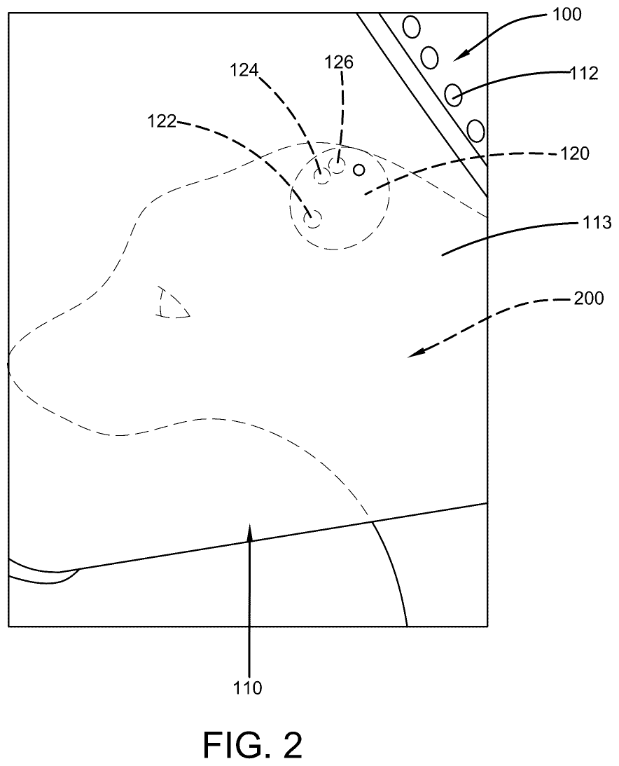

Notwithstanding the forgoing, the calming cone device 100 of the present invention can be of any suitable size and configuration as is known in the art without affecting the overall concept of the invention, provided that it accomplishes the above-stated objectives. One of ordinary skill in the art will appreciate that the calming cone device 100 as shown in FIGS. 1 and 2 is for illustrative purposes only, and that many other sizes and shapes of the calming cone device 100 are well within the scope of the present disclosure. Although the dimensions of the calming cone device 100 are important design parameters for user convenience, the calming cone device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet collar device comprising:
a cone body comprised of a first fastener; and
a Bluetooth component attached to an interior surface of the cone body via a second fastener, wherein the Bluetooth component is comprised of a transmitter and a speaker.

2. The pet collar device of claim 1, wherein the cone body is comprised of an HDPE material, a nylon material, a textile material, a heat-sealable plastic material, an ABS material, or a polypropylene material.

3. The pet collar device of claim 1, wherein the first fastener is comprised of a hook and loop fastener, a snap button fastener, a buckle fastener, a strap and buckle fastener, a magnet fastener, or a zipper fastener.

4. The pet collar device of claim 1, wherein the cone body is comprised of an indicia.

5. The pet collar device of claim 4, wherein the indicia is comprised of a pattern, a logo, an emblem, an image, a symbol, a design, a letter, a word, a character, an animal, an advertisement, or a brand.

6. The pet collar device of claim 1, wherein the second fastener is comprised of a hook and loop fastener, an adhesive fastener, or a magnet fastener.

7. The pet collar device of claim 1, wherein the Bluetooth component is comprised of a wireless transmitter.

8. A pet collar device comprising:
a cone body
a fastener; and
a Bluetooth component attached to an interior surface of the cone body, wherein the Bluetooth component comprised of a transmitter, a power button, a volume button, and a speaker.

9. The pet collar device calming cone device of claim 8, wherein the transmitter is comprised of a wireless transmitter.

10. The pet collar device of claim 9, wherein the Bluetooth component is comprised of a pairing button.

11. The pet collar device of claim 10, wherein the pairing button controls the wireless transmitter.

12. The pet collar device of claim 7, wherein the volume button controls a volume of the speaker.

13. The pet collar device of claim 7, wherein the Bluetooth component is comprised of a battery.

14. The pet collar device of claim 13, wherein the battery is comprised of a rechargeable battery.

15. The pet collar device of claim 14, wherein the battery is comprised of a charging port.

16. The pet collar device of claim 15, wherein the charging port is comprised of a USB port.

17. A method of using a pet collar device calming cone device, the method comprising the following steps:
providing the pet collar device that is comprised of a body, a fastener and a Bluetooth component having a speaker;
fastening the body around a head of a pet via the fastener;
turning on the Bluetooth component and pairing the Bluetooth component to a smart device; and
playing a sound from the speaker via the smart device.

18. The method of using pet collar device a calming cone device of claim 17, wherein the Bluetooth component is comprised of a wireless transmitter.

19. The method of using pet collar device a calming cone device of claim 17, wherein the Bluetooth component is further comprised of a battery.

20. The method of using pet collar device a calming cone device of claim 19, wherein the battery is comprised of a charging port.
